(19) United States
(12) Patent Application Publication
(10) Pub. No.: US 2015/0014257 A1
(43) Pub. Date: Jan. 15, 2015

(54) KCH HYBRID SCREEN CHANGERS

(71) Applicants: Kenneth Cavanagh, Woonsocket, RI (US); John Whaley, Woonsocket, RI (US)

(72) Inventors: Kenneth Cavanagh, Woonsocket, RI (US); John Whaley, Woonsocket, RI (US)

(73) Assignee: PARKINSON MACHINERY & MANUFACTURING, Woonsocket, RI (US)

(21) Appl. No.: 14/236,380

(22) PCT Filed: Mar. 25, 2013
(86) PCT No.: PCT/US2013/033654

§ 371 Date: Jan. 31, 2014

(30) Foreign Application Priority Data
Mar. 26, 2012 (US) 61615581

(51) Int. Cl. B01D 29/09; B29C 47/68

(52) U.S. Cl. CPC B01D 29/09; B29C 47/68
USPC 210/774; 210/232; 210/181

(57) ABSTRACT

A screen filter comprises a housing defining a melt passage for molten thermoplastic material. A guide channel in the housing is configured and arranged to direct a continuous screen filter across the melt passage. A gate blocks an exit section of the guide channel during initial formation of a solidified plug of the material being filtered on the screen filter. The gate is then partially withdrawn to an intermediate position at which it acts as a brake to releasably impede movement of the plug and screen filter until a screen change is required. The gate is then fully withdrawn and the screen filter and the plug formed thereon are pulled across the melt passage by an exterior clamp mechanism.

### PRIORITY

The present application claims priority to U.S. Provisional Patent Application Ser. No. 61/615,581 filed Mar. 26, 2012, which is hereby incorporated by reference in its entirety.

### FIELD OF THE INVENTION

This invention relates to continuous screen changers for filtering contaminants from melt flows of thermoplastic materials.

### BACKGROUND

In one type of known screen changer, the inlet and exit blocks are permanently water cooled. A solidified plug of polymer is formed on the screen extending through the exit block. The screen is moved by heating the exit block to allow movement of the solidified polymer plug, taking with it the dirty screen and pulling a fresh clean section of the screen across the melt flow passage. With this design, the ability to react rapidly to needed screen advancement is adversely delayed by the time required to reheat the solidified polymer plug. In another type of known screen changer, the screen is specially designed with longitudinally spaced transverse seals. The seals serve to prevent molten polymer from escaping through the inlet and exit sections of the screen guide channel. Experience has shown that this design is suitable for filtering some but not all polymers.

### SUMMARY OF THE INVENTION

The objective of the present invention is to provide an improved screen changer that is free of the drawbacks associated with the above described known designs.

In accordance with the present invention, a filter housing defines a melt passage for the thermoplastic material being filtered. A guide channel in the housing is configured and arranged to direct a continuous screen filter across the melt passage. A gate blocks the exit section of the guide channel during initial formation of a solidified plug of the material being filtered on the screen filter. The gate is then partially withdrawn to an intermediate position at which it acts as a brake to releasably impede movement of the plug and screen filter until a screen change is required. The gate is then fully withdrawn and the screen filter and the plug formed thereon is pulled across the melt passage by an exterior clamp mechanism.

### BRIEF DESCRIPTION OF THE DRAWINGS

An exemplary embodiment of a screen changer in accordance with the present invention is illustrated in the accompanying drawings, wherein:

FIG. 1 is a horizontal section through the screen changer showing the clamp assembly in its open setting, and at a first position adjacent to the exit section of the guide channel;

FIG. 2 is a view similar to FIG. 1 showing the clamp assembly in its closed setting gripping the screen;

FIG. 3 is a view similar to FIGS. 1 and 2 showing the closed clamp assembly retracted to a second position spaced from the first position; and

FIG. 4A-4C are enlarged views showing successive stages in the operation of the gate.

### DETAILED DESCRIPTION

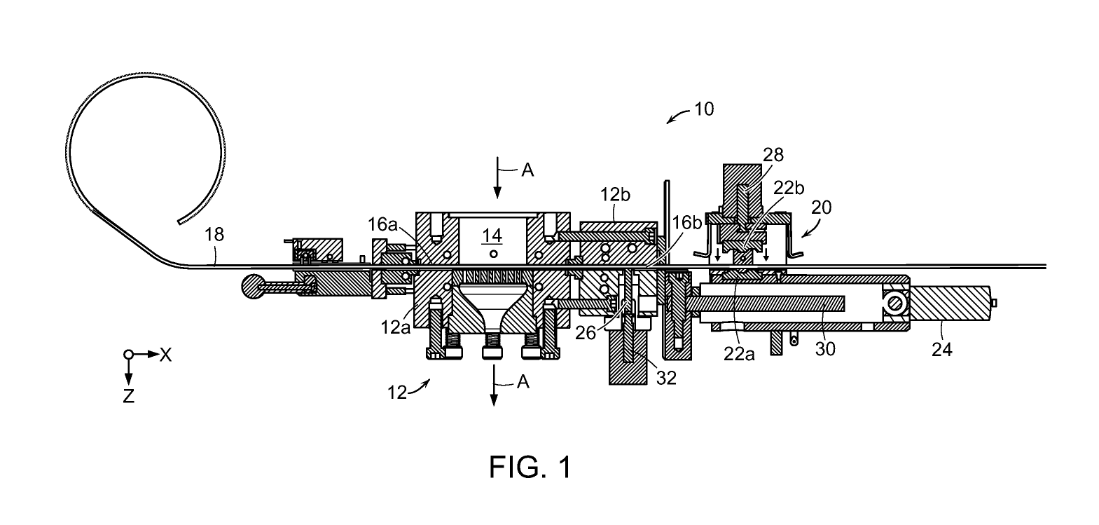

With reference initially to FIG. 1, an exemplary embodiment of a screen changer in accordance with the present invention is generally depicted at 10. The screen changer comprises a housing 12 having interconnected sections 12a, 12b. The housing defines a melt passage 14 for heated thermoplastic materials flowing in the direction of arrows “A”, and a transverse guide channel having entry and exit sections 16a, 16b for directing a continuous screen filter 18 across the melt passage 14.

Coolant is circulated through passages 17 in the housing section 12b to form a solidified plug “P” of the thermoplastic material on the screen filter 18 exiting from the melt passage 14.

A clamp assembly 20 is located on the exit side of the housing section 12b. The clamp assembly comprises fixed and movable jaws 22a, 22b located on opposite sides of the path of the exiting screen filter. The clamp assembly 20 serves to releasably grip the screen filter 18 and is mounted on a guide bar 24 for reciprocal movement in opposite directions.

A gate 26 is arranged in housing section 12b for movement in opposite directions transverse to the exit section 16b of the guide channel.

First, second and third operating means, which may comprise linear actuators 28, 30 and 32 or their mechanical equivalents, serve to shift the moveable clamp assembly 20, the gate 26 and the clamp jaw 22b in their respective directions of movement.

Prior to commencing a filtering operation, the clamp jaw 22b is opened and the gate 26 is fully retracted from the exit section 16b of the guide channel to thereby accommodate the threading of the screen filter 18 through the housing.

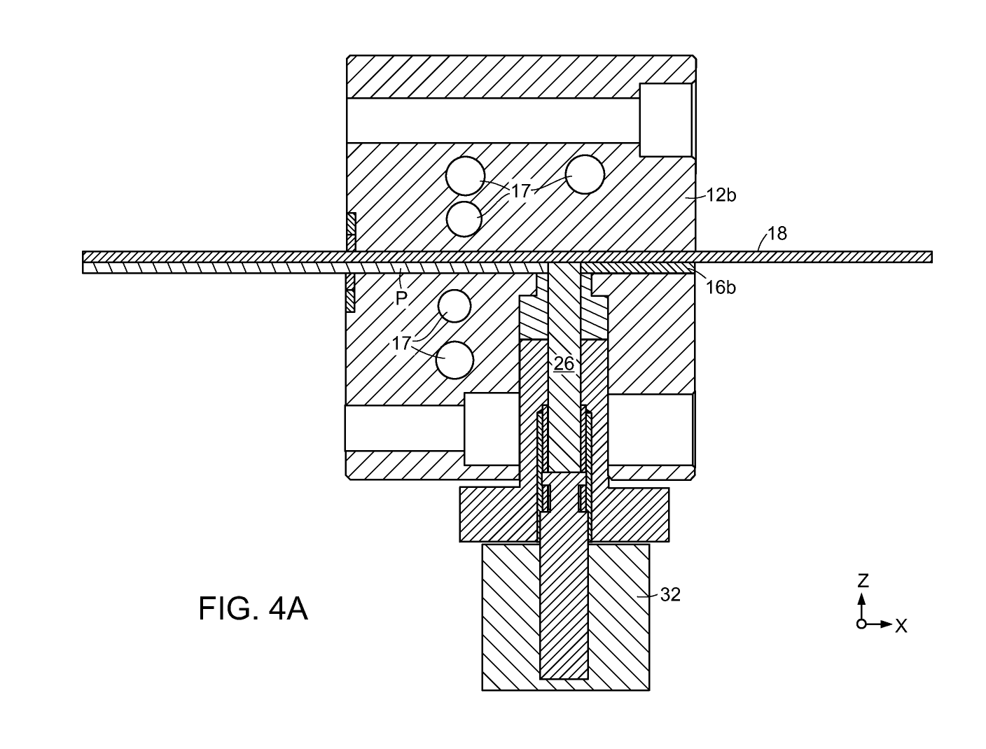

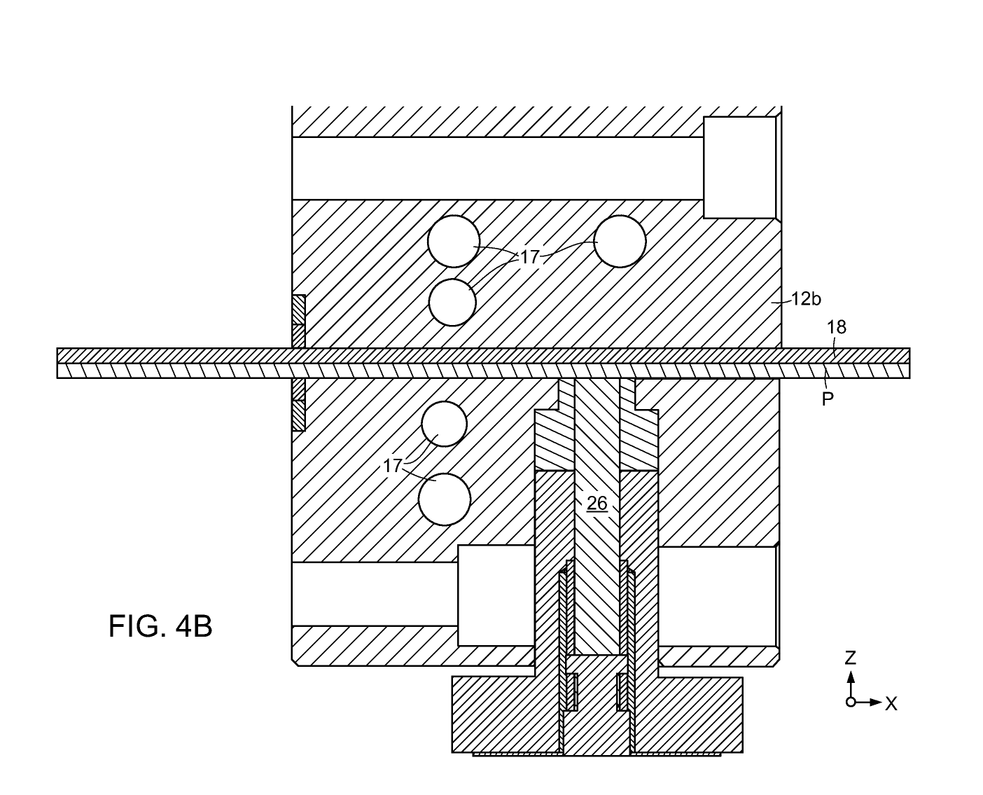

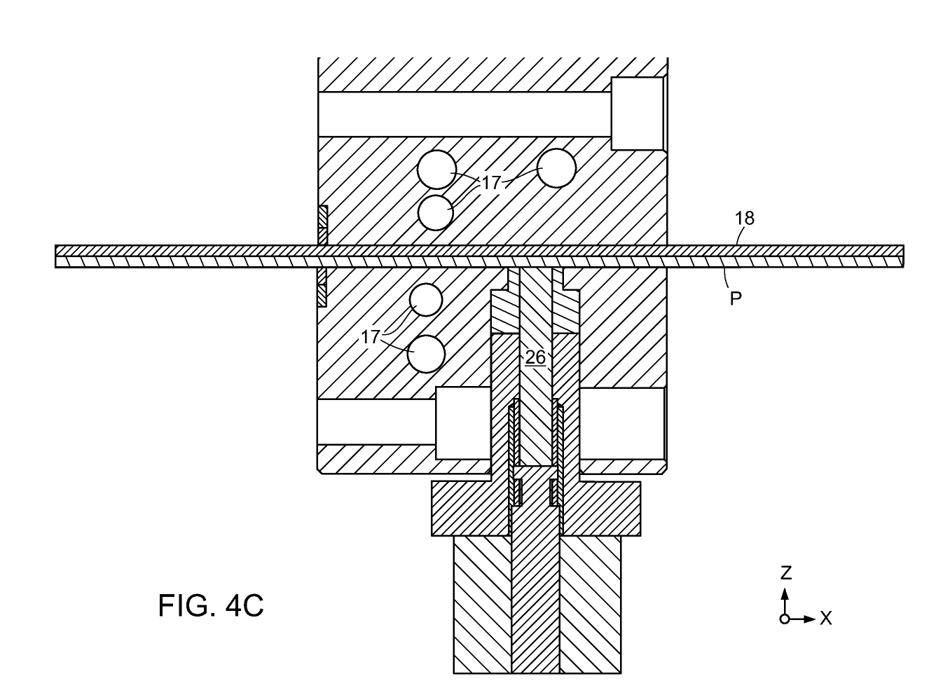

The gate 26 is then adjusted to the closed position shown in FIG. 4A, pinching the screen filter 18 against the adjacent guide channel wall to thereby seal the exit section 16b of the guide channel against any escape of the flowable thermoplastic material. Thereafter, during an initial stage of a filtering operation, coolant is circulated through the passages 17 to form a solidified plug “P” of thermoplastic material on the screen filter 18 inboard of the closed gate 26.

Once this has taken place, the gate 26 is partially retracted to the position shown in FIG. 4B, thereafter serving as a brake frictionally impeding movement of the screen filter and its solidified plug “P” along the exit section 16b of the guide channel.

The screen filter is moved across the melt passage 14 at a rate that may optionally be performed manually, or controlled by a timer, or triggered in response to increases in melt pressure that occur as contaminants accumulate on the screen filter.

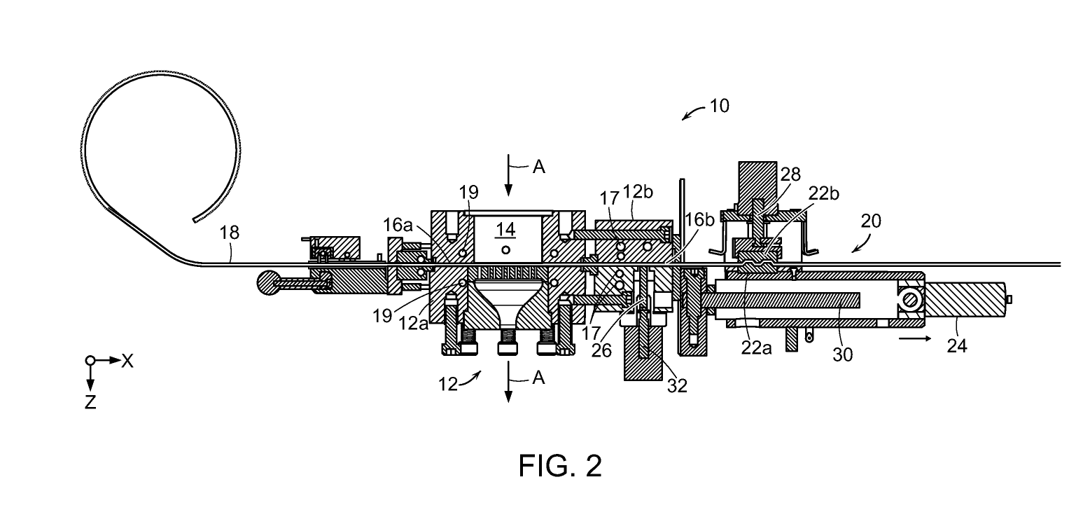

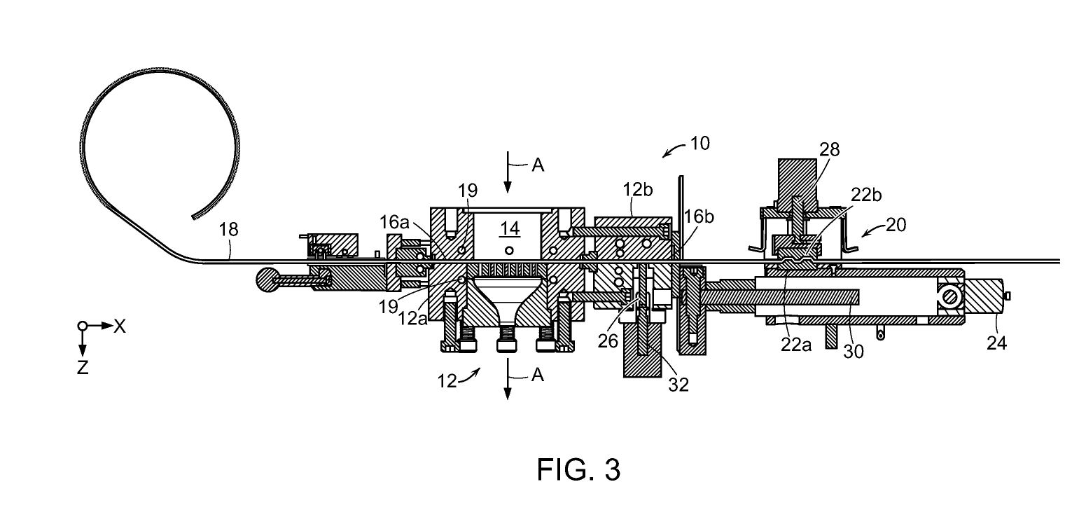

The screen filter is advanced by first closing the movable jaw 22b of the clamp assembly 20, as shown in FIG. 2, to grip a section of the screen filter carrying the solidified plug “P”. The gate 26 is then fully retracted as shown in FIG. 4C, thus releasing the gate's frictional impediment to movement of the screen filter and plug. Then, as shown in FIG. 3, the clamp assembly 20 is shifted away from housing section 26 to a second position spaced from the first position, thereby pulling the screen filter across the melt passage.

The apparatus may then be readied for the next screen shifting sequence by opening jaw 22b, returning the clamp assembly 20 to the first position shown in FIG. 1, and repositioning the gate 26 to its braking position as shown in FIG. 4B.

The exit section 16b is generously dimensioned to accommodate incremental advancement of the screen filter 18 and solidified plug “P”. In contrast, the entry section 16a of the guide channel is configured to tightly confine the screen filter 18. Additional coolant channels 19 in the vicinity of the entry section serve to solidify any coating of the thermoplastic material that may adhere to the entering screen filter, thus serving to seal off the entry section 16a.

While only one embodiment of the invention has been shown and described in detail, it will now be apparent to those skilled in the art that many modifications and variations are possible, satisfying many or all of the objects of the invention, without departing from the spirit thereof as defined by the appended claims.

What is claimed is:

1. Apparatus for filtering a thermoplastic material heated to a flowable state, said apparatus comprising:
a housing defining a through melt passage for the heated thermoplastic material, and a guide channel having entry and exit sections arranged on opposite sides of said melt passage and configured to direct a continuous screen filter transversely across said melt passage from an entry side to an exit side of said housing;
a clamp assembly for releasably gripping said screen filter at a first location on the exit side of said housing; and
first operating means for shifting said clamp assembly to a second location remote from said first location to thereby incrementally advance said screen filter across said melt passage.

2. The apparatus of claim 1 further comprising means for accommodating a flow of coolant through said housing in the vicinity of the exit section of said guide channel to thereby form a solidified plug of said thermoplastic material in said exit section and on said screen filter.

3. The apparatus of claim 2 further comprising a gate reciprocally moveable in directions transverse to the exit section of said guide channel, and second operating means for advancing said gate into said exit section to engage said screen filter and to seal said exit section against escape of said thermoplastic material during the formation of said plug.

4. The apparatus of claim 3 wherein following formation of said plug, said second operating means serves to partially retract said gate to an intermediate position frictionally impeding movement of said plug and screen filter along the exit section of said guide channel.

5. The apparatus of claim 1 wherein said clamp assembly comprises fixed and moveable jaws, and third operating means for advancing and retracting said movable jaw to grip and release said screen filter.

6. The apparatus of claim 1 wherein said clamp assembly is supported for reciprocal movement on a guide bar projecting from said housing in a direction parallel to the exit path of said screen filter.

7. A method of filtering a thermoplastic material heated to a flowable state, said method comprising:
directing the heated thermoplastic material along a melt passage in a housing;
providing a guide channel having entry and exit sections arranged on opposite sides of said melt passage, said entry and exit sections being configured to direct a continuous screen filter transversely across said melt passage from an entry side to an exit side of said housing;
temporarily sealing the exit section of said guide channel during the formation of a solidified plug of said thermoplastic material in said exit section and on said screen filter;
frictionally impeding movement of the thus formed plug and screen filter through the exit section of said guide channel;
releasing said frictional impediment; and
gripping and pulling said plug and said screen filter out of said exit section, thereby incrementally advancing said screen filter across said melt passage.
